(19) United States
(12) Patent Application Publication
(10) Pub. No.: US 2015/0185385 A1
(43) Pub. Date: Jul. 2, 2015

(54) OPTICALLY ANISOTROPIC FILM

(71) Applicant: SUMITOMO CHEMICAL COMPANY, LIMITED, Tokyo (JP)

(72) Inventors: Tadahiro KOBAYASHI, Osaka-shi (JP); Atsunobu KOYAMA, Osaka-shi (JP); Takumi FUJIGAYA, Osaka-shi (JP)

(73) Assignee: SUMITOMO CHEMICAL COMPANY, LIMITED, Tokyo (JP)

(21) Appl. No.: 14/559,344

(22) Filed: Dec. 3, 2014

(30) Foreign Application Priority Data
Dec. 5, 2013 (JP) 2013-251760

(51) Int. Cl. G02B 5/30; C09K 19/38

(52) U.S. Cl. CPC G02B 5/3016; C09K 19/3809

(57) ABSTRACT

Provided is an optically anisotropic film high in transparency. The film is an optically anisotropic film having a refractive index relationship of nz>nx>ny wherein: nz represents a refractive index of an index ellipsoid which the optically anisotropic film forms, the refractive index being the refractive index thereof in a direction vertical to a plane of the film; nx represents another refractive index of the index ellipsoid, the refractive index being the main refractive index thereof in a direction parallel to the plane of the film; and ny represents still another refractive index of the index ellipsoid, the refractive index being the refractive index thereof in a direction parallel to the plane of the film and perpendicular to the direction related to the refractive index nx. The film further includes a polymer of a polymerizable liquid crystal compound, and an organic modified polysiloxane.

### BACKGROUND OF THE INVENTION

1. Field of the Invention

The present invention relates to an optically anisotropic film.

2. Description of the Related Art

A flat panel display device (FPD) makes use of a member including an optically anisotropic film such as a polarizing plate or a retardation plate. As such an optically anisotropic film, known is an optically anisotropic film produced by applying a composition containing a polymerizable liquid crystal compound to a substrate. For example, JP-A-2007-148098 describes an optically anisotropic film formed by applying a composition containing a polymerizable liquid crystal compound onto a substrate subjected to orienting treatment, and then polymerizing the polymerizable liquid crystal compound.

### SUMMARY OF THE INVENTION

Conventional optically anisotropic films are not sufficient in transparency.

The present invention includes the following aspects or embodiments:

[1] An optically anisotropic film comprising a polymer of a polymerizable liquid crystal compound and an organic modified polysiloxane and having a refractive index relationship of nz>nx>ny
where nz represents a refractive index of an index ellipsoid formed from the optically anisotropic film, the refractive index being taken in a direction vertical to a plane of the film; nx represents a main refractive index of the index ellipsoid formed from the optically anisotropic film, this refractive index being taken in a direction parallel to the plane of the film; and ny represents a refractive index of the index ellipsoid formed from the optically anisotropic film, this refractive index being taken in a direction parallel to the plane of the film and perpendicular to the direction in which the refractive index nx is taken.
[2] The optically anisotropic film according to item [1], wherein the content of the organic modified polysiloxane is from 0.1 to 30 parts by mass relative to 100 parts by mass of the optically anisotropic film.
[3] The optically anisotropic film according to item [1] or [2], wherein the polymer of the polymerizable liquid crystal compound is a polymer of a vertically oriented polymerizable liquid crystal compound.
[4] The optically anisotropic film according to any one of items [1] to [3], wherein the organic modified polysiloxane has a polyether-modified polydimethylsiloxane structure.
[5] The optically anisotropic film according to any one of items [1] to [4], the film having the water contact angle of from 70° to 100°.
[6] The optically anisotropic film according to any one of items [1] to [5], the film being obtained from a composition for forming an optically anisotropic film, the composition comprising the polymerizable liquid crystal compound and the organic modified polysiloxane.
[7] The optically anisotropic film according to any one of items [1] to [6], the film being for an in-plane switching (IPS) liquid crystal display device.
[8] A retardation film comprising the optically anisotropic film according to any one of items [1] to [7].
[9] A polarizing plate comprising the optically anisotropic film according to any one of items [1] to [7].
[10] A display device comprising the optically anisotropic film according to any one of items [1] to [7].
[11] A composition for forming an optically anisotropic film, the composition comprising a polymerizable liquid crystal compound and an organic modified polysiloxane in an amount of 0.1 to 30 parts by mass relative to 100 parts by mass of the polymerizable liquid crystal compound.
[12] The composition according to item [11] further comprising a compound having an isocyanate group.

The optically anisotropic film of the present invention is high in transparency.

### BRIEF DESCRIPTION OF THE DRAWINGS

FIGS. 1A, 1B, 1C, 1D, and 1E are schematic views illustrating an example of the polarizing plate according to the present invention; and

FIGS. 2A and 2B are schematic views illustrating an example of the liquid crystal display device according to the invention.

### DETAILED DESCRIPTION OF THE PREFERRED EMBODIMENTS

The optically anisotropic film of the present invention (hereinafter referred to as the present optically anisotropic film) contains a polymer of a polymerizable liquid crystal compound, and an organic modified polysiloxane. The present optically anisotropic film preferably contains, as a main component thereof, a polymer of a polymerizable liquid crystal compound.

### <Optically Anisotropic Film>

The present optically anisotropic film has a refractive index relationship represented by nz>nx>ny wherein: nx represents a main refractive index of an index ellipsoid formed from the optically anisotropic film, the refractive index being taken in a direction parallel to a plane of the film; ny represents a refractive index of the index ellipsoid, this refractive index being taken in a direction parallel to the plane of the film and perpendicular to the direction in which the refractive index nx is taken; and nz represents a refractive index of the index ellipsoid, this refractive index being taken in a direction vertical to the plane of the film.

In the present optically anisotropic film, the front retardation value Re (550) thereof to a light ray of 550 nm wavelength is preferably from 0 to 10 nm, more preferably from 0 to 5 nm. The thickness direction retardation value Rth is preferably from −10 to −300 nm, more preferably from −20 to −200 nm. A film having such optical properties among the present optically anisotropic film, are suitable for compensation for liquid crystal display devices in an in-plane switching (IPS) mode.

The value Rth can be calculated from the retardation value R₅₀ measured, when the in-plane fast axis of the optically anisotropic film is regarded as an inclined axis, and inclining the plane of the optically anisotropic film at 50 degrees to the fast axis, and the in-plane retardation value R₀. The value Rth can be obtained with the in-plane retardation value R₀, the retardation value R₅₀, which is measured in the state of rendering the in-plane fast axis an inclined axis, and inclining the plane of the optically anisotropic film at 50 degrees to the fast axis, the optically anisotropic film thickness d, and the average refractive index n₀ of the optically anisotropic film and by calculating the refractive indexes nx, ny and nz through equations (9) to (11) described below; and then substituting these refractive indexes for an equation (8) described below:

Rth=[(nx+ny)/2−nz]×d (8),

R0=(nx−ny)×d (9),

R50=(nx−ny′)×d/cos(φ) (10),

and

(nx+ny+nz)/3=n₀ (11)

wherein φ=)sin⁻¹[sin(50°)/n₀], and

ny′=ny×nz/[ny²×sin²(φ)+nz²×cos²(φ)]^{1/2}.

The thickness of the optically anisotropic film is preferably from 0.1 to 10 μm, and is more preferably from 0.2 to 5 μm in the viewpoint of making the optically anisotropic film small in photoelasticity.

Examples of the state of the orientation of the polymerizable liquid crystal compound include horizontal orientation, vertical orientation, hybrid orientation, and oblique orientation. The state is preferably vertical orientation. The present optically anisotropic film preferably contains a polymer made from a vertically oriented polymerizable liquid crystal compound.

The expressions “horizontal” and “vertical”, expressions related thereto represent the orientation direction of a long axis of the polymerizable liquid crystal compound, to the reference of this direction being a plane of a substrate on which the optically anisotropic film is formed. The expression “vertical orientation” denotes that the polymerizable liquid crystal compound has a long axis along a direction vertical to the substrate plane on which the optically anisotropic film is formed. The word “vertical” herein means 90°±20°.

The water contact angle to the front surface of the present optically anisotropic film is preferably from 70° to 100°, more preferably from 80° to 95°, even more preferably from 85° to 95° in order to make it easy to apply an adhesive or the like onto the present optically anisotropic film, resulting from making wettability on the front surface of the present optically anisotropic film higher.

The haze value of the present optically anisotropic film is usually 1.5% or less, preferably 0.5% or less, more preferably 0.3% or less, even more preferably 0.25% or less. The smaller haze value means higher transparency.

The scattering or dispersion of the thickness distribution of the present optically anisotropic film is usually 5% or less, preferably 4% or less, more preferably less than 3%, even more preferably 2% or less.

### <Organic Modified Polysiloxane>

The organic modified polysiloxane are, for example, polyether modified polydimethylsiloxane, alkyl modified polydimethylsiloxane, polyester modified polydimethylsiloxane, or aralkyl modified polydimethylsiloxane, and is preferably polyether modified polydimethylsiloxane.

The organic modified polysiloxane can be produced by a known method, and can be produced by, for example, a method described in each of Synthesis Examples 1, 2, 3 and 4 in JP-A-04-242499, Reference Examples in JP-A-09-165318, and others. The organic modified polysiloxane may be a commercially available material. Specific examples of the organic modified polysiloxane include products TSF4445, and TSF4446 (each manufactured by GE Toshiba Silicones Co., Ltd.); products SH200, SH3746M, DC3PA, and ST869A (manufactured by Dow Corning Toray Co., Ltd.); KP series products (manufactured by Shin-Etsu Chemical Co., Ltd.); and products BYK-302, BYK-306, BYK-307, BYK-330, and BYK-370 (manufactured by BYK-Chemie Japan K.K.).

Such organic modified polysiloxanes may be used alone or in any combination of two or more thereof.

The content of the organic modified polysiloxane is usually from 0.1 to 30 parts by mass, preferably from 0.1 to 10 parts by mass, more preferably from 0.2 to 1 part by mass relative to 100 parts by mass of the present optically anisotropic film.

The present optically anisotropic film can be usually produced by applying, onto a substrate, a composition for forming an optically anisotropic film containing a polymerizable liquid crystal compound and an organic modified polysiloxane, and then polymerizing the applied polymerizable liquid crystal compound.

### <Substrate>

The substrate is preferably a resin substrate.

The resin substrate is usually a transparent resin substrate. The transparent resin substrate means a substrate having such a translucency that light, in particular, visible rays can be transmitted through the substrate. Translucency denotes a property that the transmittance of light rays having wavelengths from 380 to 780 nm is 80% or more. The resin substrate is usually a resin substrate in a film form, and is preferably an elongated film roll.

Examples of the resin that constitutes the substrate include polyolefins such as polyethylene, polypropylene, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; and polyphenylene oxides. The resin is, out of these examples, preferably any polyolefin such as polyethylene, polypropylene or norbornene-based polymer.

The substrate may be subjected to surface treatment. Examples of the method for the surface treatment include a method of treating a surface of the substrate with corona or plasma under from the evacuated atmosphere to the atmosphere pressure; a method of treating a surface of the substrate with a laser; a method of treating a surface of the substrate with ozone; a method of subjecting a surface of the substrate to saponifying treatment; a method of subjecting a surface of the substrate to flame treatment; a method of applying a coupling agent onto a surface of the substrate; a method of subjecting a surface of the substrate to primer treatment; and a method of causing a reactive monomer or a polymer having reactivity to adhere onto a surface of the substrate, and then radiating radial rays, plasma or ultraviolet rays thereto to cause a reaction of the monomer or polymer, thereby attaining graft-polymerization. Of these examples, preferred is the method of treating a surface of the substrate with corona or plasma under from the evacuated atmosphere to the atmosphere pressure.

The method of treating a surface of the substrate with corona or plasma is, for example, a method i) of setting the substrate between opposed electrodes under a pressure close to the atmospheric pressure, and then generating corona or plasma to treat the surface of the substrate therewith, a method ii) of causing a gas to flow into the gap between opposed electrodes, making the gas into plasma between the electrodes, and blowing the plasma-state gas onto the surface of the substrate; or a method iii) of generating glow discharge plasma under a low pressure to treat the surface of the substrate therewith.

Of these methods, preferred are the methods i) and ii). Usually, these surface treatments with corona or plasma can be conducted in a commercially available surface treatment apparatus.

The substrate may have a protective film on a surface of the substrate that is reverse to the surface thereof to which the composition for forming an optically anisotropic film is to be applied. Examples of the protective film include films made of polyethylene, polyethylene terephthalate, polycarbonate, or any polyolefin; and a film in which any one of these films further has an adhesive layer. Of these films, a polyethylene terephthalate film is preferred since the film is small in thermal deformation when dried. When the substrate has the protective film on the substrate surface reverse to the substrate surface to which the composition for forming an optically anisotropic film is to be applied, it is possible to restrain the swinging of the film or a slight vibration of the composition-applied surface when the substrate is carried. As a result, the applied film can be improved in evenness.

The thickness of the substrate is usually from 5 to 300 μm, preferably from 20 to 200 μm.

The length in the longitudinal direction of the roll of elongated film is usually from 10 to 3000 m, preferably from 100 to 2000 m. The length in the short direction of the elongated film roll is usually from 0.1 to 5 m, preferably from 0.2 to 2 m.

### <Orientation Film>

An orientation film is preferably formed on a surface of the substrate that is a surface thereof to which the composition for forming an optically anisotropic film is to be applied.

The orientation film is a film having orientation regulating force for orienting the polymerizable liquid crystal compound into a desired direction as described later in detail.

The orientation film is preferably a film having such a solvent resistance that the film is not dissolved by applying the composition for forming an optically anisotropic film or such an operation, and having a heat resistance in heating treatment for the removal of the solvent and for orienting the polymerizable liquid crystal compound. Examples of the orientation film include an orientation film containing an orienting polymer, an optically orientation film, and a groove orientation film having on its surface an irregularity pattern or plural grooves.

Such an orientation film makes the orientation of the polymerizable liquid crystal compound easy. In accordance with the kind of the orientation film, or rubbing conditions, the orientation can be controlled into various orientations such as horizontal orientation, vertical orientation, hybrid orientation, and oblique orientation.

The thickness of the orientation film is usually from 10 to 10000 nm, preferably from 10 to 1000 nm, more preferably 500 nm or less, even more preferably from 10 to 200 nm.

### <Orientation Film Containing Orienting Polymer>

Examples of the orienting polymer include polyamides and gelatins which have amide bonds, polyimides which have imide bonds, polyamic acids which are a hydrolyzate of a polyimide, polyvinyl alcohols, alkyl-modified polyvinyl alcohols, polyacrylamides, polyoxazoles, polyethyleneimines, polystyrenes, polyvinyl pyrrolidones, polyacrylic acids, and polyacrylates. Of these examples, polyvinyl alcohols are preferred. Two or more kind of orienting polymers may be combined.

The orientation film containing the orienting polymer is usually obtained by applying an orienting polymer composition in which the orienting polymer is dissolved in a solvent, to the above-mentioned substrate, and then removing the solvent from the applied composition to forma applied film, or by applying the orienting polymer composition onto the substrate, removing the solvent from the applied composition to forma applied film, and then rubbing the applied film.

Examples of the solvent include water; alcohol solvents such as methanol, ethanol, ethylene glycol, isopropyl alcohol, propylene glycol, methylcellosolve, butylcellosolve, and propylene glycol monomethyl ether; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; aliphatic hydrocarbon solvents such as pentane, hexane and heptane; aromatic hydrocarbon solvents such as toluene, and xylene; nitrile solvents such as acetonitrile; ether solvents such as tetrahydrofuran, and dimethoxyethane; and chlorinated hydrocarbon solvents such as chloroform and chlorobenzene. Such solvents may be used in any combination of two or more kinds.

It is sufficient for the concentration of the orienting polymer in the orienting polymer composition to be in the range of concentrations at which the orienting polymer is completely soluble in the solvent. The content by percentage of the orienting polymer in the orienting polymer composition is preferably from 0.1 to 20%, more preferably from 0.1 to 10%.

The orienting polymer composition is commercially available. Examples of the commercially available orienting polymer composition include products SUNEVER (registered trademark, manufactured by Nissan Chemical Industries, Ltd.), and OPTMER (registered trademark, manufactured by JSR Corp.).

The method for applying the orienting polymer composition onto the substrate may be a known method, examples thereof include coating methods such as spin coating, extrusion coating, gravure coating, die coating, slit coating, bar coating, and applicator coating methods; and printing methods such as flexography. When the optically anisotropic film is produced by a continuous producing method in a roll-to-roll manner as described later in detail, the applying method (used in the producing method) may be usually a gravure coating or die coating method, or a printing method such as flexography.

Examples of the method for removing the solvent contained in the orienting polymer composition include natural drying, ventilation drying, heat drying, and reduced-pressure drying; and any combination of two or more of these methods. The drying temperature is preferably from 10 to 250° C., more preferably from 25 to 200° C. The drying period which depends on the kind of the solvent is preferably from 5 seconds to 60 minutes, more preferably from 10 seconds to 30 minutes.

The applied film formed from the orienting polymer composition may be subjected to rubbing treatment. The rubbing treatment makes it possible to give orientation regulating force to the applied film.

The method for the rubbing treatment is a method of bringing the applied film into contact with a rubbing roll that is wound with a rubbing cloth and being rotated.

When the applied film is partially masked before the rubbing treatment, plural regions (patterns) different from each other in orientation direction can be formed in the orientation film.

### <Optically Orientation Film>

The example of the optically orientation film is usually obtained by applying onto a substrate a composition for forming an optically orientation film containing a polymer or monomer having an optically reactive group and a solvent, and then radiating polarized light (preferably polarized UV rays) onto the resultant substrate. In the optically orientation film, the direction of its orientation regulating force can be controlled at will by selecting the polarization direction of the radiated polarized light.

The optically reactive group denotes a group which undergoes light radiation to generate orienting capability. The group is specifically a group related to a photoreaction from which the orienting capability originates, such as orientation-inducing reaction, isomerization reaction, photo-dimerization reaction, optically crosslinking reaction, or photo-decomposition reaction of molecules that is caused by light radiation. The optically reactive group is preferably a group having an unsaturated bond, particularly, a double bond. The optically reactive group is in particular preferably a group having at least one selected from the group consisting of a carbon-carbon double bond (C═C bond), a carbon-nitrogen double bond (C═N bond), a nitrogen-nitrogen double bond (N═N bond), and a carbon-oxygen double bond (C═O bond).

Examples of the optically reactive group having a C═C bond include vinyl, polyene, stilbene, stilbazole, stilbazolium, chalcone, and cinnamoyl groups. Examples of the optically reactive group having a C═N bond include groups each having an aromatic Schiff base, an aromatic hydrazone or some other structures. Examples of the optically reactive group having a N═N bond include azobenzene, azonaphthalene, aromatic heterocyclic azo, bisazo and formazan groups, and a group having an azoxybenzene structure. Examples of the optically reactive group having a C═O bond include benzophenone, coumarin, anthraquinone, and maleimide groups. These groups may have one or more substituents, such as alkyl, alkoxy, aryl, allyloxy, cyano, alkoxycarbonyl, hydroxyl, sulfonate, and halogenated alkyl groups.

The optically reactive group is preferably a group involved in photo-dimerization reaction or optically crosslinking reaction since the group gives an excellent orientation. The optically reactive group related to photo-dimerization reaction is particularly preferred. Cinnamoyl and chalcone groups are preferred since the groups make the radiation dose of polarized light necessary for orientation relatively small, and further easily give an optically orientation film excellent in thermal stability, and stability over time. The polymer having an optically reactive group is in particular preferably a polymer having a cinnamoyl group which makes a terminal region of a side chain of the polymer into a cinnamic acid structure.

By applying the composition for forming an optically orientation film onto the substrate, an optical orientation-inducing layer can be formed on the substrate. The examples of a solvent contained in this composition include the same as those contained in the above-mentioned orienting polymer composition, and may be selected in accordance with the solubility of the polymer or monomer that has optically reactive group to the solvent.

The content of the polymer or monomer that has optically reactive group in the composition for forming orientation film is adjustable in accordance with the kind of the polymer or monomer and the thickness of a target optically orientation film, and is preferably at least 0.2% by mass, more preferably from 0.3 to 10% by mass. The composition for forming an optically orientation film may contain a polymeric material such as polyvinyl alcohol or polyimide, and a photosensitizer as far as properties of the optically orientation film are not remarkably deteriorated.

The examples of method for applying the composition for forming an optically orientation film onto the substrate may be the same as those used for applying the orienting polymer composition onto the substrate. The examples of method for removing the solvent from the applied composition for forming orientation film may be the same method as used for removing the solvent from the orienting polymer composition.

For the radiation of the polarized light, any one of the following is usable: a manner of radiating the polarized light onto a film obtained by removing the solvent from the composition for forming an optically orientation film applied on the substrate, so as to apply the light directly onto the applied composition; or a manner of radiating the polarized light onto the film from the substrate side thereof to penetrate the substrate, thereby being radiated to the applied composition. Rays of the polarized light are preferably substantially parallel rays. The wavelength of the radiated polarized light is preferably in the range of wavelengths so that the optically reactive group of the polymer or monomer which has the optically reactive group can be absorbed the optical energy. Specifically, the wavelength is in particular preferably from 250 to 400 nm, which correspond to UV rays (ultraviolet rays). Examples of alight source for radiating the polarized light include a xenon lamp, a high-pressure mercury lamp, a super-high-pressure mercury lamp, a metal halide lamp, and ultraviolet lasers such as KrF and ArF lasers. Of these examples, preferred are high-pressure mercury, super-high-pressure mercury, and metal halide lamps since the lamps emit an ultraviolet ray of 313 nm wavelength with a high emission intensity. By radiating light from the light source through an appropriate polarizing layer onto the applied composition for forming orientation film, polarized UV rays can be radiated thereto. Examples of the polarizing layer include a polarizing filter, polarizing prisms such as Glan-Thomson and Glan-Taylor prisms, and a wire-grid-type polarizing layer.

Plural different regions (patterns) in orientation direction can be formed by masking, when the polarized light is radiated.

### <Groove Orientation Film>

The groove orientation film is a film having an irregularity pattern or plural grooves on its surface. When liquid crystal molecules are put on a film having grooves in the form of straight lines arranged at regular intervals, the liquid crystal molecules are oriented in a direction along the grooves.

Examples of the method for obtaining the groove orientation film include a method of exposing a surface of a photosensitive polyimide film through a mask for exposure having slits in a pattern form to light, and then developing and rinsing treatments to form an irregularity pattern; a method of forming an uncured UV curable resin layer onto an original plate having, grooves on its surface thereof, transferring the resin layer onto a substrate, and then curing the resin layer; and a method of pushing an original roll having grooves onto an uncured UV curable resin film formed on a substrate to form irregularities, and then curing the resin film. The detailed examples are described in JP-A-06-34976, JP-A-2011-242743, and others.

Among the above-mentioned methods, preferred is the method of pushing an original roll having grooves onto an uncured UV curable resin film formed on a substrate to form irregularities, and then curing the resin film. The original roll is preferably made of stainless (SUS) steel from the viewpoint of durability.

The UV curable resin may be a resin made from a monofunctional acrylate, a polyfunctional acrylate, or a mixture of these two.

The monofunctional acrylate is a compound having one selected from the group consisting of an acryloyloxy group (CH₂═CH—COO—) and a methacryloyloxy group (CH₂═C(CH₃)—COO—) (the two may be collectively referred to as a (meth)acryloyloxy group hereinafter). The wording “(meth)acrylate” denotes acrylate or methacrylate.

Examples of the monofunctional acrylate having one (meth)acryloyloxy group include alkyl (meth)acrylates each having 4 to 16 carbon atoms, β-carboxyalkyl (meth)acrylates each having 2 to 14 carbon atoms, alkylated phenyl (meth)acrylates each having 2 to 14 carbon atoms, methoxypolyethylene glycol (meth)acrylate, phenoxypolyethylene glycol (meth)acrylate, and isobornyl (meth)acrylate.

The polyfunctional acrylate is a compound having two or more (meth)acryloyloxy groups, and is preferably a compound having 2 to 6 (meth)acryloyloxy groups.

Examples of the polyfunctional acrylate having two (meth)acryloyloxy groups include 1,3-butanediol di(meth)acrylate; 1,6-hexanediol di(meth)acrylate; ethylene glycol di(meth)acrylate; diethylene glycol di(meth)acrylate; neopentylglycol di(meth)acrylate; triethylene glycol di(meth)acrylate; tetraethylene glycol di(meth)acrylate; polyethylene glycol diacrylate; bis(acryloyloxyethyl)ether of bisphenol A; ethoxylated bisphenol A di(meth)acrylate; propoxylated neopentylglycol di(meth)acrylate; ethoxylated neopentyl glycol di(meth)acrylate; and 3-methylpentanediol di(meth)acrylate.

Examples of the polyfunctional acrylate having 3 to 6 (meth)acryloyloxy groups include trimethylolpropane tri(meth)acrylate; pentaerythritol tri(meth)acrylate; tris(2-hydroxyethyl)isocyanurate tri(meth)acrylate; ethoxylated trimethylolpropane tri(meth)acrylate; propoxylated trimethylolpropane tri(meth)acrylate; pentaerythritol tetra(meth)acrylate; dipentaerythritol penta(meth)acrylate; dipentaerythritol hexa(meth)acrylate; tripentaerythritol tetra(meth)acrylate; tripentaerythritol penta(meth)acrylate; tripentaerythritol hexa(meth)acrylate; tripentaerythritol hepta(meth)acrylate; tripentaerythritol octa(meth)acrylate;

a reaction product made from pentaerythritol tri(meth)acrylate and an acid anhydride; a reaction product made from dipentaerythritol penta(meth)acrylate and an acid anhydride; a reaction product made from tripentaerythritol hepta(meth)acrylate and an acid anhydride;

caprolactone modified trimethylolpropane tri(meth)acrylate; caprolactone modified pentaerythritol tri(meth)acrylate; caprolactone modified tris(2-hydroxyethyl)isocyanurate tri(meth)acrylate; caprolactone modified pentaerythritol tetra(meth)acrylate; caprolactone modified dipentaerythritol penta(meth)acrylate; caprolactone modified dipentaerythritol hexa(meth)acrylate; caprolactone modified tripentaerythritol tetra (meth)acrylate; caprolactone modified tripentaerythritol penta (meth)acrylate; caprolactone modified tripentaerythritol hexa(meth)acrylate; caprolactone modified tripentaerythritol hepta (meth)acrylate; caprolactone modified tripentaerythritol octa(meth)acrylate; a reaction product made form caprolactone modified pentaerythritol tri(meth)acrylate and an acid anhydride; a reaction product made from caprolactone modified dipentaerythritol penta(meth)acrylate and an acid anhydride; and a reaction product made from caprolactone modified tripentaerythritol hepta(meth)acrylate and an acid anhydride.

The wording “caprolactone modified” means that a ring-opened product from caprolactone or a ring-opened polymer therefrom is introduced into a moiety between an alcohol-originating moiety of a (meth)acrylate compound and an (meth)acryloyloxy group thereof.

The polyfunctional acrylate is commercially available. Examples of a commercially available product thereof include products A-DOD-N, A-HD-N, A-NOD-N, APG-100, APG-200, APG-400, A-GLY-9E, A-GLY-20E, A-TMM-3, A-TMPT, AD-TMP, ATM-35E, A-TMMT, A-9550, A-DPH, HD-N, NOD-N, NPG, and TMPT (manufactured by Shin-Nakamura Chemical Co., Ltd.); products ARONIXes “M-220”, “M-325”, “M-240”, “M-270”, “M-309”, “M-310”, “M-321”, “M-350”, “M-360”, “M-305”, “M-306”, “M-450”, “M-451”, “M-408”, “M-400”, “M-402”, “M-403”, “M-404”, “M-405”, and “M-406” (manufactured by Toagosei Co., Ltd.); and products EBECRYLs “11”, “145”, 150”, “40”, “140”, and “180”, and DPGDA, HDDA, TPGDA, HPNDA, PETIA, PETRA, TMPTA, TMPEOTA, DPHA, and EBECRYL series (manufactured by Daicel-Cytec Co., Ltd.).

The width of convexes of the irregularities of the groove orientation film is preferably from 0.05 to 5 μm, the width of concaves thereof is preferably from 0.1 to 5 μm, and the difference in level on the depth is preferably 2 μm or less, more preferably from 0.01 to 1 μm in order to obtain an orientation in smaller orientation disturbance.

### <Composition for Forming an Optically Anisotropic Film>

The examples of organic modified polysiloxane contained in the composition for forming optically anisotropic film may be the same as described above.

The content of the organic modified polysiloxane in the composition for forming an optically anisotropic film is usually from 0.1 to 30 parts by mass, preferably from 0.1 to 10 parts by mass, more preferably from 0.2 to 1 part by mass relative to 100 parts by mass of the polymerizable liquid crystal compound in the composition.

### <Polymerizable Liquid Crystal Compound>

The polymerizable liquid crystal compound may be, for example, a compound containing a group represented by a formula (X) shown below (hereinafter, the compound may be referred to as the “compound (X)”). The polymerizable liquid crystal compound may be a single species, or two or more species different from each other in structure in combination.

P¹¹-B¹¹-F¹¹-B¹²-A¹¹-B¹³- (X)

wherein: P¹¹ represents a hydrogen atom or a polymerizable group;

A¹¹ represents a bivalent alicyclic hydrocarbon group or bivalent aromatic hydrocarbon group provided that any hydrogen atom contained in the bivalent alicyclic hydrocarbon group or bivalent aromatic hydrocarbon group may be substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms may be substituted with a fluorine atom;

B¹¹ represents —O—, —S—, —CO—O—, —O—CO—, —O—CO—O—, —CO—NR¹⁶—, —NR¹⁶—CO—, —CO—, —CS— or a single bond wherein R¹⁶s each represent a hydrogen atom or an alkyl group having 1 to 6 carbon atoms (the same applies to the following R¹⁶s);

B¹² and B¹³ each independently represent —C≡C—, —CH═CH—, —CH₂—CH₂—, —O—, —S—, —C(═O)—, —C(═O)—O—, —O—C(═O)—, —O—C(═O)—O—, CH═N, N═CH, N═N, C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond; and

E¹¹ represents an alkanediyl group having 1 to 12 carbon atoms provided that any hydrogen atom contained in the alkanediyl group may be substituted with an alkoxy group having 1 to 5 carbon atoms provided that any hydrogen atom contained in the alkoxy group may be substituted with a halogen atom, and provided that any —CH₂— that constitutes the alkanediyl group may be replaced with —O— or —CO—.

The number of the carbon atoms of the aromatic hydrocarbon group or alicyclic hydrocarbon group as A¹¹ is preferably from 3 to 18, more preferably from 5 to 12, in particular preferably 5 or 6. A¹¹ is preferably a cyclohexane-1,4-diyl group, or 1,4-phenylene group.

E¹¹ is preferably a linear alkanediyl group having 1 to 12 carbon atoms. Any —CH₂— that constitutes the alkanediyl group may be replaced with —O—.

Specific examples of the group include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; and —CH₂—CH₂—O—CH₂—CH₂—, —CH₂—CH₂—O—CH₂—CH₂—O—CH₂—CH₂—, and —CH₂—CH₂—O—CH₂—CH₂—O—CH₂—CH₂—O—CH₂—CH₂—.

B¹¹ is preferably —O—, —S—, —CO—O—, or —O—CO—, more preferably —CO—O—.

B¹² and B¹³ are each independently preferably —O—, —S—, —C(═O)—, —C(═O)—O—, —O—C(═O)—, or —O—C(═O)—O—, more preferably —O—, or —O—C(═O)—O—.

The polymerizable group represented by P¹¹ is preferably a radical polymerizable group or cation polymerizable group since the group has a higher reactivity for polymerization reactivity, in particular, the reactivity for photopolymerization. The polymerizable group is preferably a group represented by any one of the following formulae (P-11) to (P-15), or a stilbene group since the liquid crystal compound having the group is easy to handle, and is also easily produced:

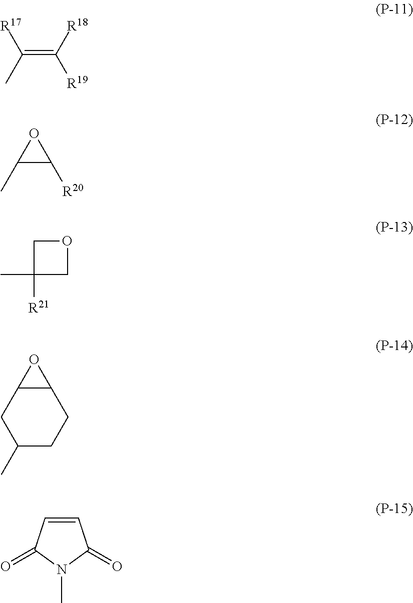

wherein R¹⁷ to R²¹ each independently represent an alkyl group having 1 to 6 carbon atoms, or a hydrogen atom.

Specific examples of the group represented by any one of the formulae (P-11) to (P-13) include respective groups represented by the following formulae (P-16) to (P-20), and a p-stilbene group:

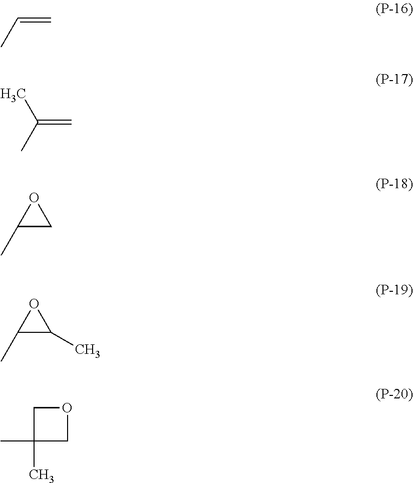

P¹¹ is preferably a group represented by any one of the formulae (P-14) to (P-20), more preferably a vinyl, epoxy or oxetanyl group.

More preferably, the group represented by P¹¹-B¹¹- is an acryloyloxy or methacryloyloxy group.

Examples of the compound (X) include respective compounds represented by the following formulae (I), (II), (III), (IV), (V) and (VI):

P¹¹-B¹¹-E¹¹-B¹²-A¹¹-B¹³-A¹²-B¹⁴-A¹³-B¹⁵-A¹⁴-B¹⁶-E¹²-B¹⁷-P¹² (I),

P¹¹-B¹¹-E¹¹-B¹²-A¹¹-B¹³-A¹²-B¹⁴-A¹³-B¹⁵-A¹⁴-F¹¹ (II),

P¹¹-B¹¹-E¹¹-B¹²-A¹¹-B¹³-A¹²-B¹⁴-A¹³-B¹⁵-E¹²-B¹⁷-P¹² (III),

P¹¹-B¹¹-E¹¹-B¹²-A¹¹-B¹³-A¹²-B¹⁴-A¹³-F¹¹ (IV),

P¹¹-B¹¹-E¹¹-B¹²-A¹¹-B¹³-A¹²-B¹⁴-E¹²-B¹⁷-P¹² (V), and

P¹¹-B¹¹-E¹¹-B¹²-A¹¹-B¹³-A¹²-F¹¹ (VI)

wherein A¹² to A¹⁴ eachindependently have the same meaning as A¹¹; B¹⁴ to B¹⁶ each independently have the same meaning as B¹²; B¹⁷ has the same meaning as B¹¹; E¹² has the same meaning as E¹¹; and

F¹¹ represents a hydrogen or halogen atom, or an alkyl group having 1 to 13 carbon atoms, an alkoxy group having 1 to 13 carbon atoms, a cyano, nitro, trifluoromethyl, dimethylamino, hydroxyl, methylol, formyl, sulfo (—SO₃H) or carboxyl group, or an alkoxycarbonyl group having 1 to 10 carbon atoms provided that any —CH₂— that constitutes the alkyl or alkoxy group may be replaced with —O—.

P¹² represents a hydrogen atom or a polymerizable group, and preferably a polymerizable group, and examples thereof include the similar polymerizable groups as defined in P¹¹, and at least one of P¹¹ and P¹² is a polymerizable group.

The examples of the polymerizable liquid crystal compound include the compounds having a polymerizable group out of compounds selected from those described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); and polymerizable liquid crystal compounds described in JP-A-2010-31223, JP-A-2010-270108, JP-A-2011-6360, and JP-A-2011-207765.

The examples of the compound (X) include the compounds represented by formulae (I-1) to (I-4), formulae (II-1) to (II-4), formulae (III-1) to (III-26), formulae (IV-1) to (IV-26), formulae (V-1) and (V-2), and formulae (VI-1) to (VI-6), each of which is illustrated just below. In the formulae, k1 and k2 each independently represent an integer of 2 to 12. The respective compounds (X) represented by the formulae (I-1) to (I-4), the formulae (II-1) to (II-4), the formulae (III-1) to (111-26), the formulae (IV-1) to (IV-26), the formulae (V-1) and (V-2), and the formulae (VI-1) to (VI-6) are preferred since the compounds are easily synthesized or are easily available.

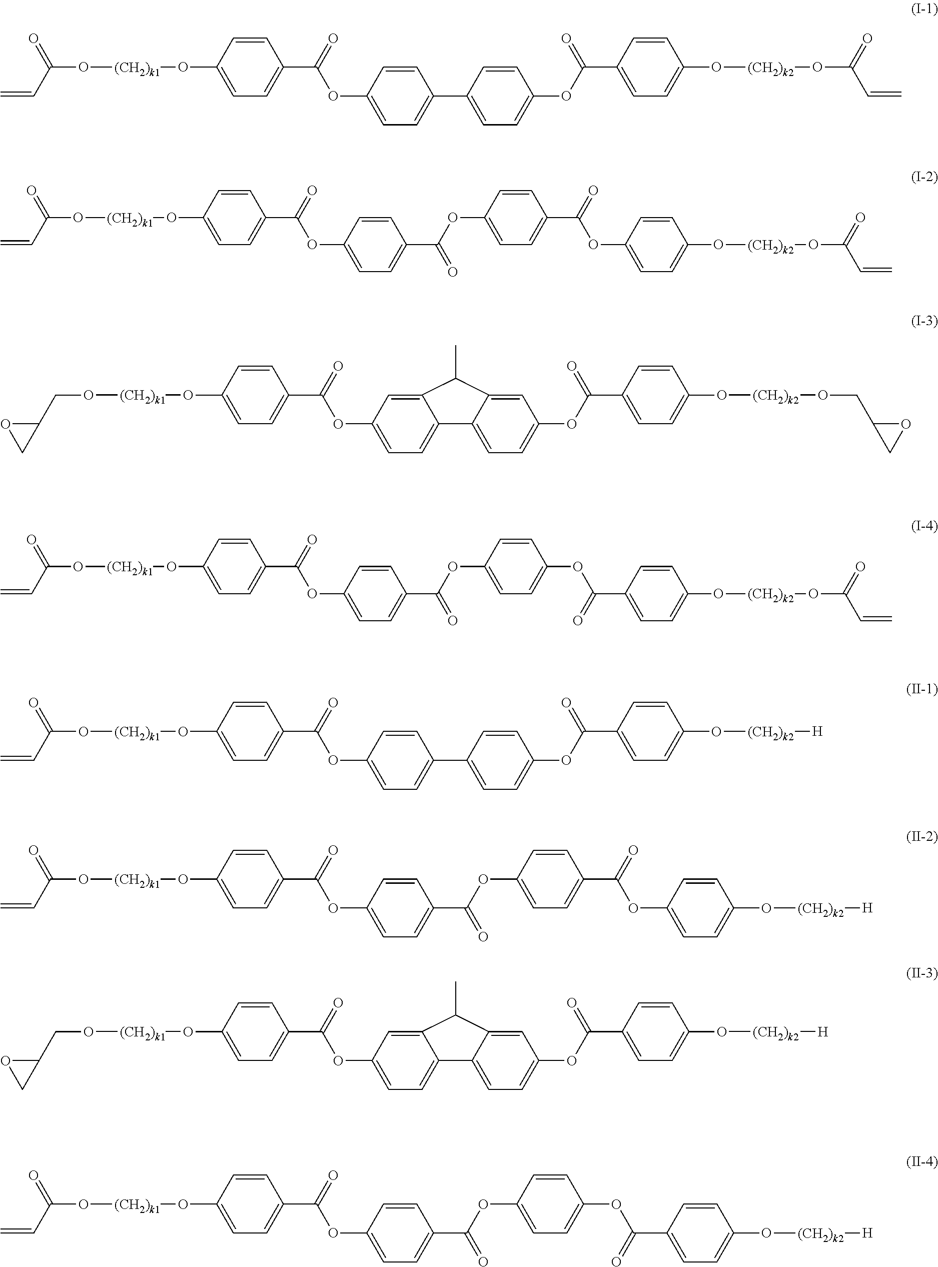

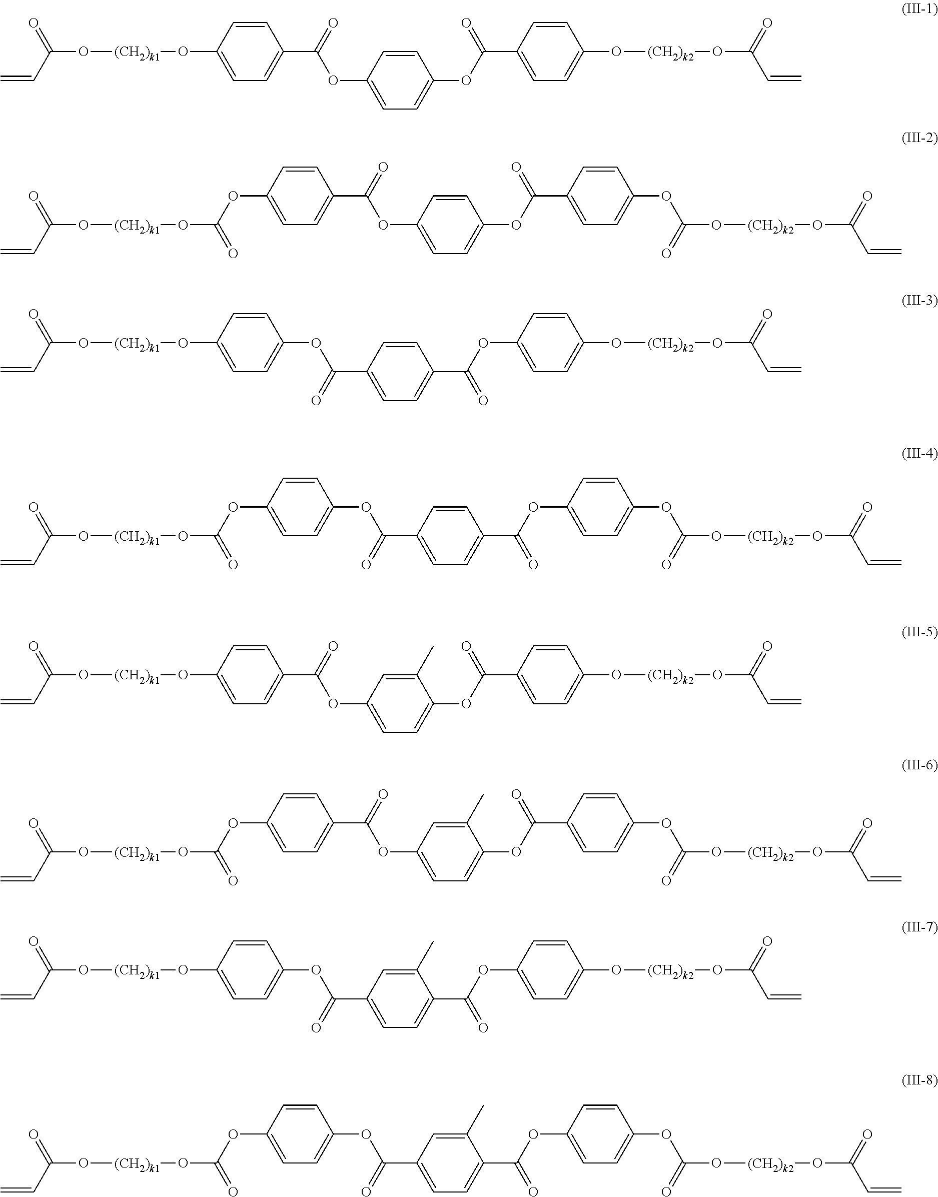

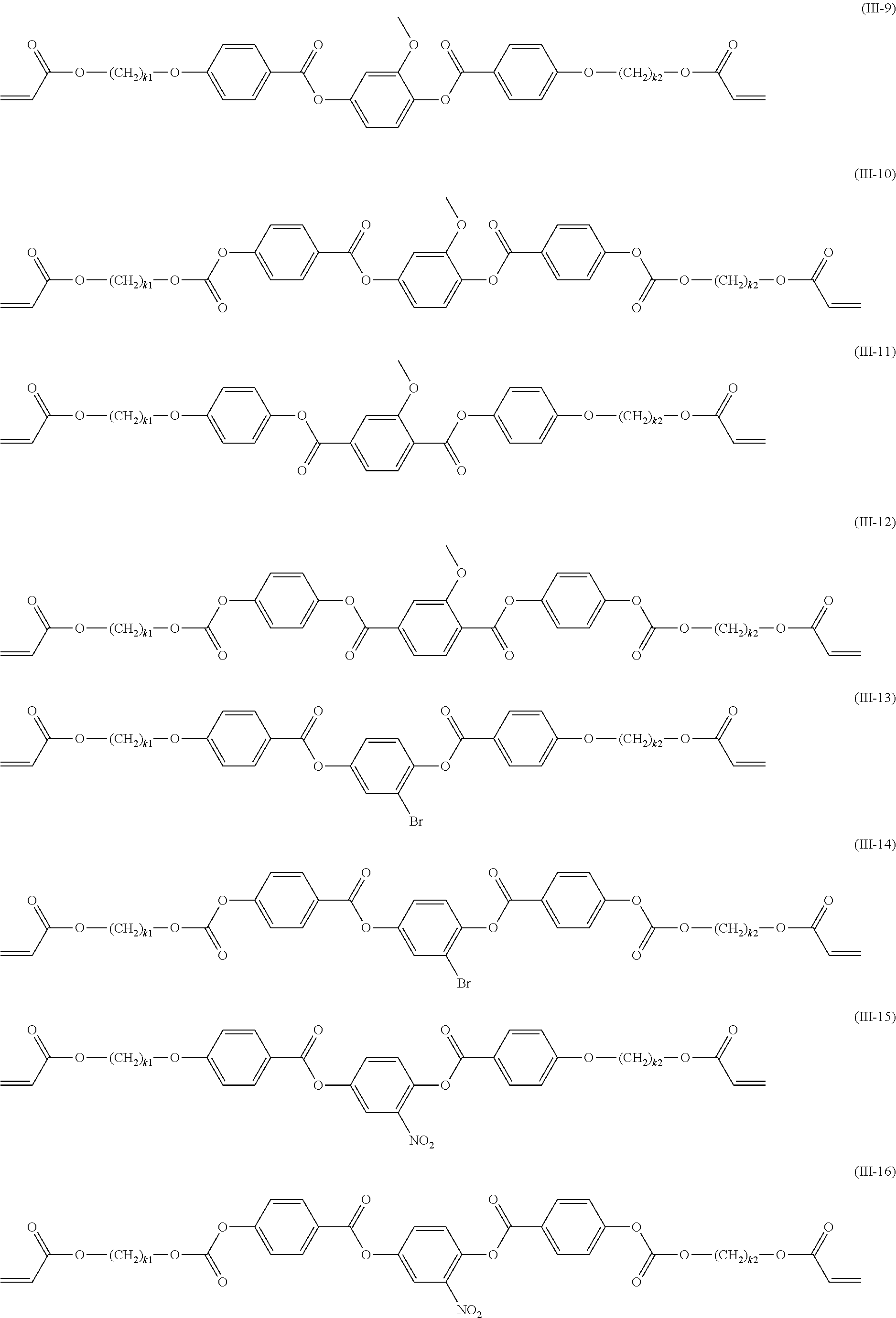

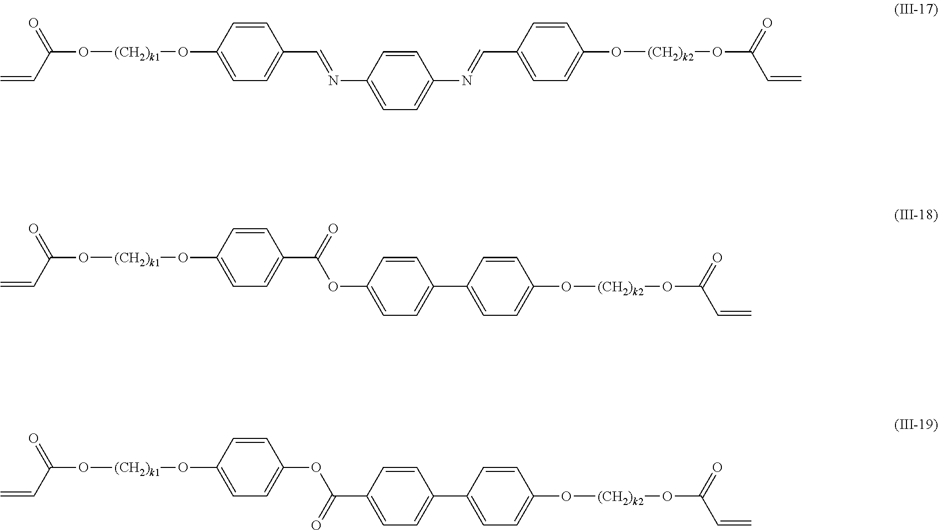

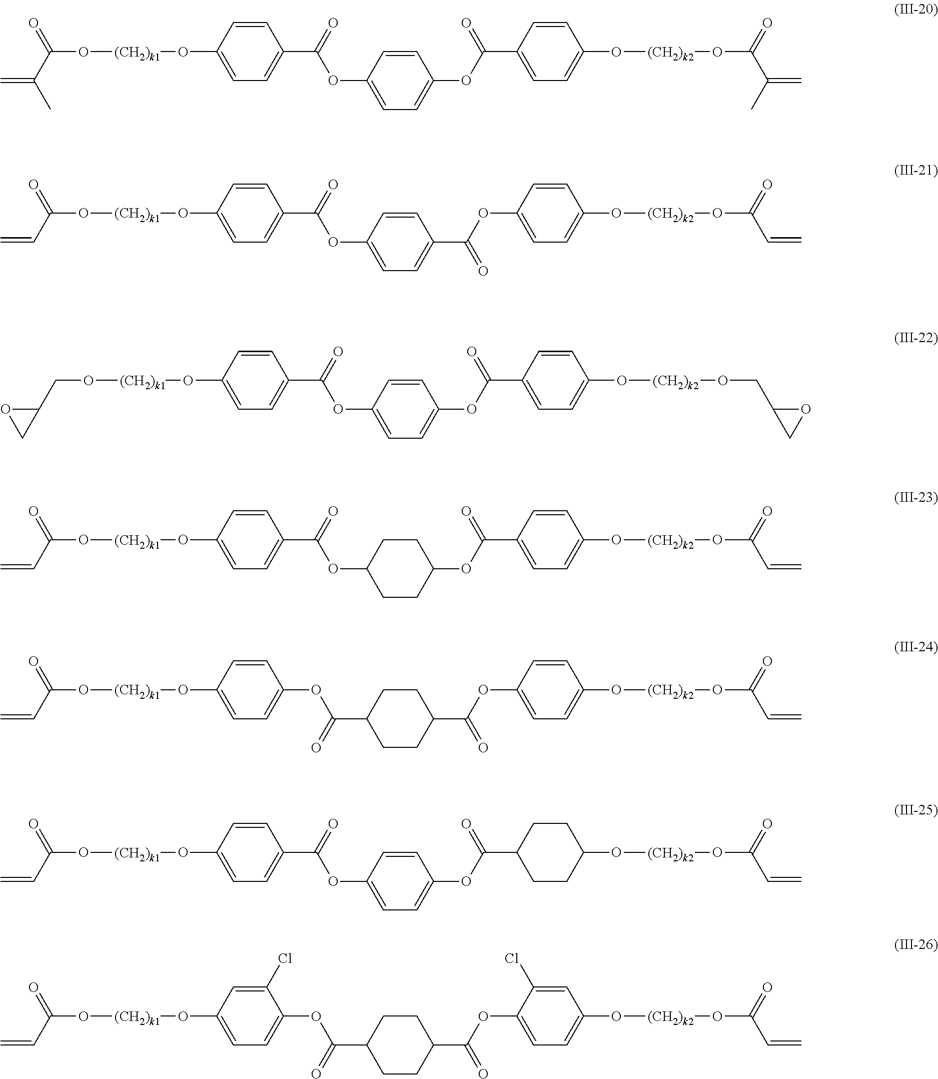

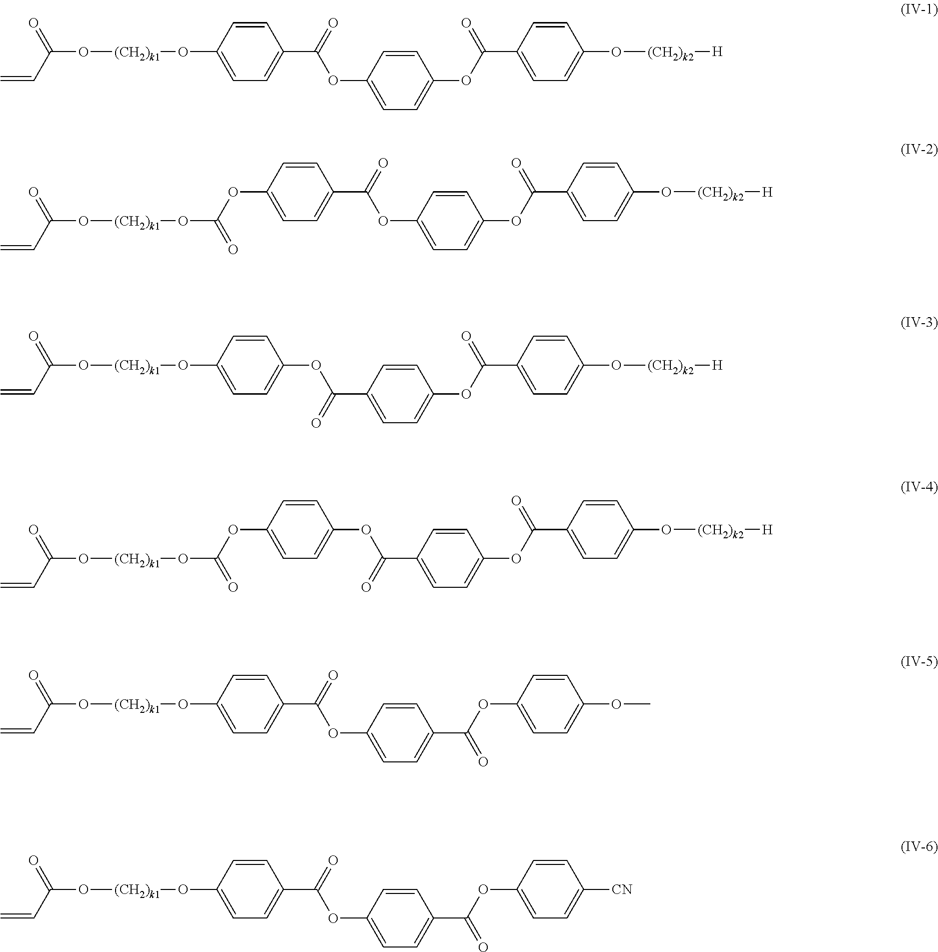

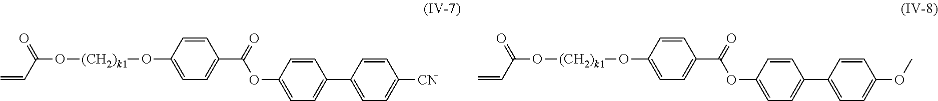

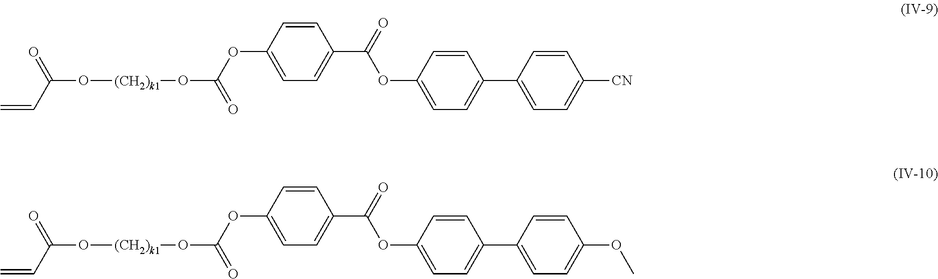

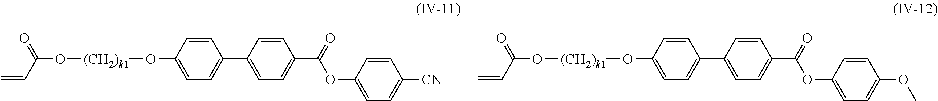

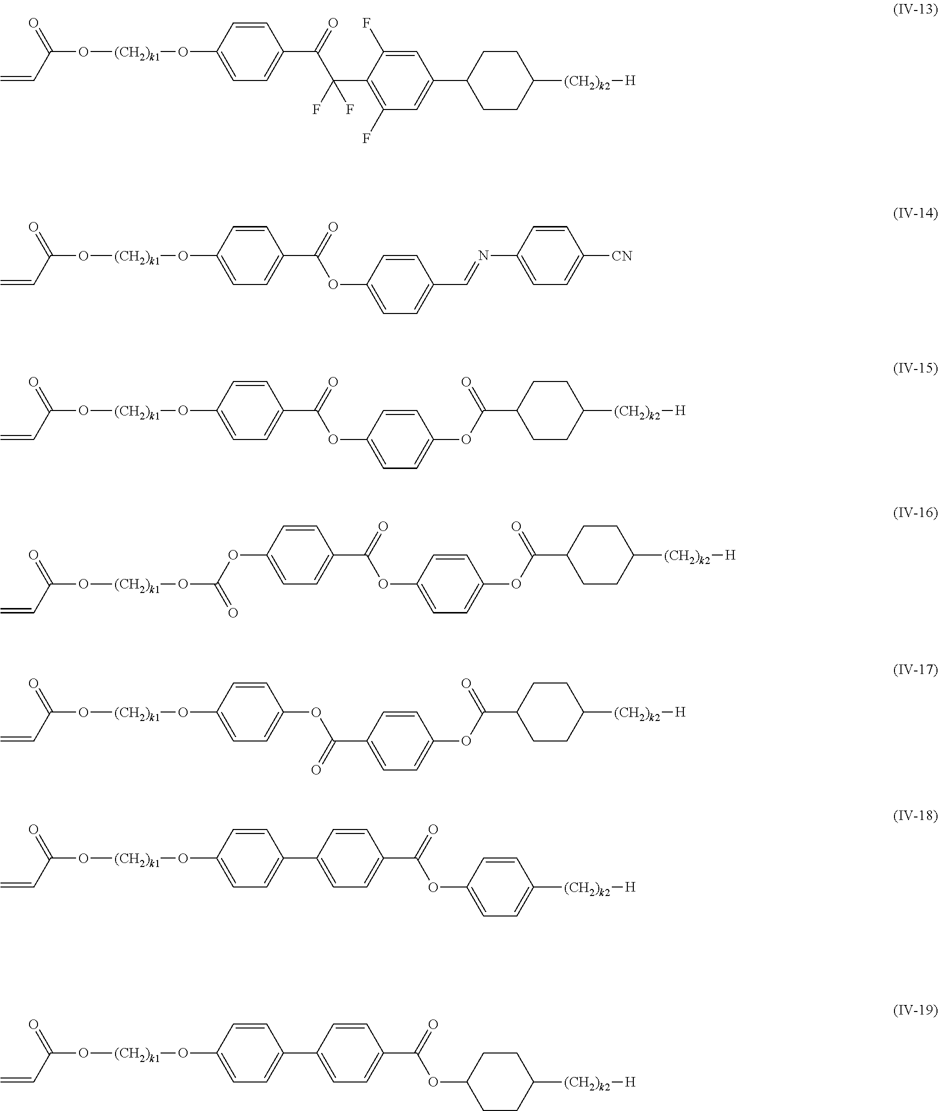

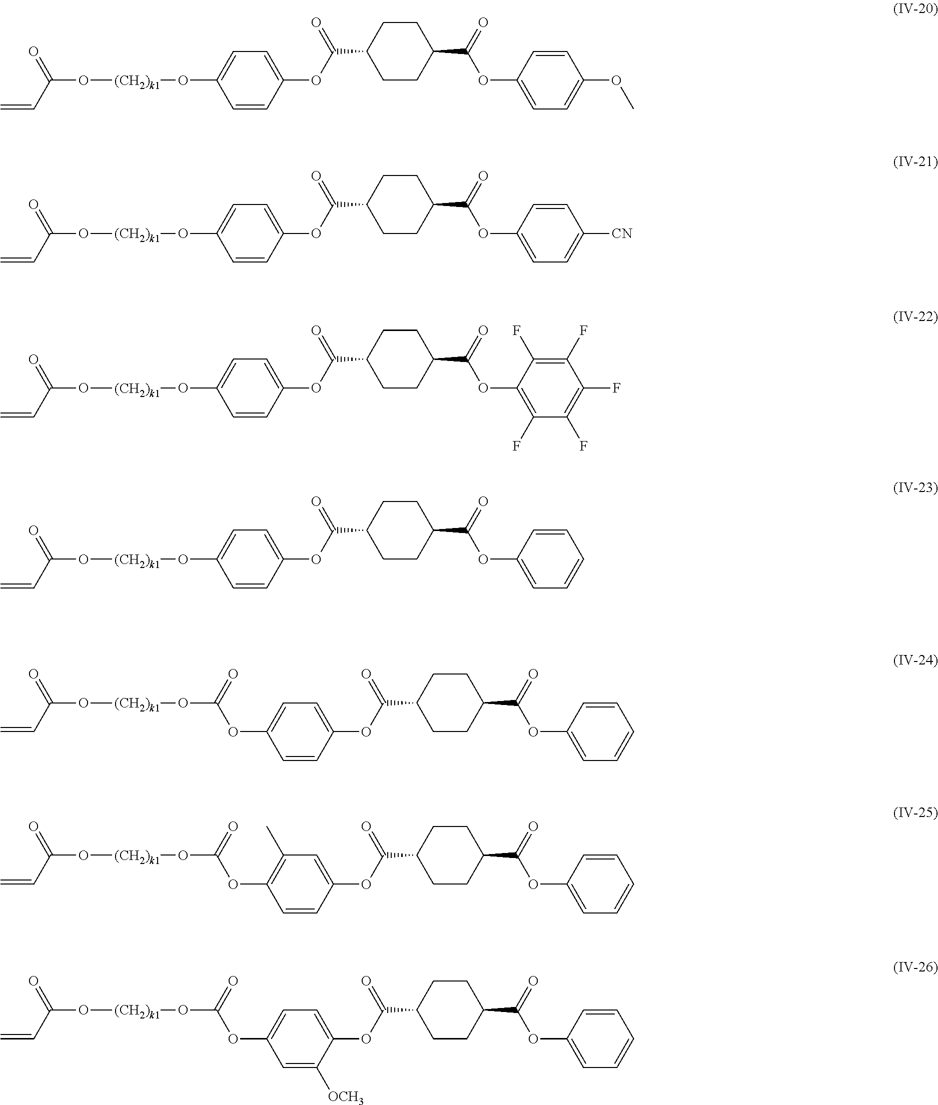

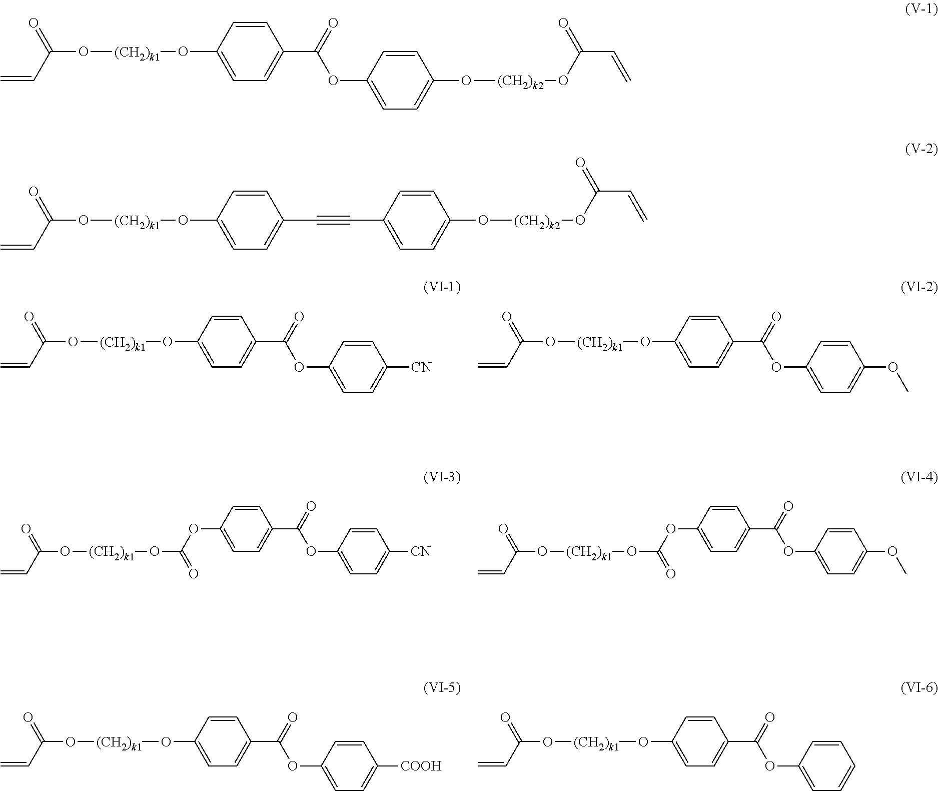

The content of the polymerizable liquid crystal compound in the composition for forming an optically anisotropic film is usually from 5 to 50 parts by mass, preferably from 10 to 30 parts by mass relative to 100 parts by mass of the composition.

Besides the polymerizable liquid crystal compound and the organic modified polysiloxane, the composition for forming an optically anisotropic film may contain a solvent, a polymerization initiator, a polymerization inhibitor, a photosensitizer, a levelling agent, a chiral agent, a reactive additive and/or other additives. The composition for forming an optically anisotropic film preferably contains a polymerization initiator.

### <Solvent>

The solvent is preferably an organic solvent which solves the component components of the composition for forming such as the polymerizable liquid crystal compound an optically anisotropic film are soluble, and is more preferably a solvent that solves the polymerizable liquid crystal compound, and other constituent components of the composition for forming an optically anisotropic film and that is inert to the polymerization reaction of the polymerizable liquid crystal compound.

The examples of the solvent include alcohol solvents such as methanol, ethanol, ethylene glycol, isopropyl alcohol, propylene glycol, methylcellosolve, butylcellosolve, propylene glycol monomethyl ether, and phenol; ester solvents such as ethyl acetate, butyl acetate, and ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane and heptane; non-chlorinated aromatic hydrocarbon solvents such as toluene, and xylene; nitrile solvents such as acetonitrile; ether solvents such as tetrahydrofuran, and dimethoxyethane; and chlorinated hydrocarbon solvents such as chloroform, and chlorobenzene. Such solvents may be used in combination of two or more thereof. Of these examples, preferred are alcohol solvents, ester solvents, ketone solvents, non-chlorinated aliphatic hydrocarbon solvents and non-chlorinated aromatic hydrocarbon solvents.

The solvent content in the composition for forming an optically anisotropic film is preferably from 10 to 10000 parts by mass, more preferably from 100 to 5000 parts by mass relative to 100 parts by mass of solids in the composition. The concentration of the solids in the composition for forming an optically anisotropic film is generally from 1 to 90% by mass, preferably from 2 to 50% by mass, more preferably from 5 to 50% by mass. The “solids” mean the entire components obtained by excluding the solvent from the composition for forming an optically anisotropic film.

### <Polymerization Initiator>

The polymerization initiator is preferably a photopolymerization initiator, more preferably a photopolymerization initiator which generates radicals by irradiating light radiation.

Examples of the photopolymerization initiator include benzoin compounds, benzophenone compounds, benzyl ketal compounds, α-hydroxyketone compounds, α-aminoketone compounds, α-acetophenone compounds, triazine compounds, iodonium salts and sulfonium salts. Specific examples thereof include the following products: IRGACUREs (registered trademark) 907, 184, 651, 819, 250 and 369 (all the products are manufactured by Ciba Japan K.K.); SEIKUOLs (registered trademark) BZ, Z, BEE (all the products are manufactured by Seiko Chemical Co., Ltd.); KAYACURE (registered trademark) BP100 (manufactured by Nippon Kayaku Co., Ltd.); KAYACURE UVI-6992 (manufactured by the Dow Chemical Company); ADEKA OPTOMERs (registered trademark) SP-152, and SP-170 (all the products are manufactured by Adeka Corporation); TAZ-A and TAZ-PP (all the products are manufactured by Nihon Siber Hegner K.K.), and TAZ-104 (manufactured by Sanwa Chemical Co., Ltd.). Of these examples, preferred are α-acetophenone compounds. Examples of the α-acetophenone compounds include 2-methyl-2-morpholino-1-(4-methyl-sulfanylphenyl)propane-1-one, 2-dimethylamino-1-(4-morpholinophenyl)-2-benzylbutane-1-one, and 2-dimethylamino-1-(4-morpholinophenyl)-2-(4-methylphenylmethyl)butane-1-one. Preferred are 2-methyl-2-morpholino-1-(4-methyl-sulfanylphenyl)propane-1-one, and 2-dimethylamino-1-(4-morpholinophenyl)-2-benzylbutane-1-one. Commercially available product examples of the α-acetophenone compounds include the following products: IRGACUREs 369, 379EG, and 907 (all the products are manufactured by BASF Japan Ltd.), and SEIKUOL BEE (manufactured by Seiko Chemical Co., Ltd.).

The content of the polymerization initiator in the composition is usually from 0.1 to 30 parts by mass, preferably from 0.5 to 10 parts by mass relative to 100 parts by mass of the polymerizable liquid crystal compound in the composition in order to polymerize the polymerizable liquid crystal compound without disturbing the orientation of the polymerizable liquid crystal compound.

### <Polymerization Inhibitor>

The polymerization inhibitor can control of the polymerization reaction of the polymerizable liquid crystal compound.

Examples of the polymerization inhibitor include hydroquinone and hydroquinone analogues each having a substituent such as an alkyl ether; butylcatechol, and other catechol compounds each having a substituent such as an alkyl ether; radical capturing agents such as pyrogallol compounds, and 2,2,6,6-tetramethyl-1-piperidinyloxy radicals; thiophenol compounds; β-naphthylamine compounds; and β-naphthol compounds.

The content of the polymerization inhibitor in the composition is usually from 0.1 to 30 parts by mass, preferably from 0.5 to 10 parts by mass relative to 100 parts by mass of the polymerizable liquid crystal compound in the composition to cause the polymerizable liquid crystal compound to be polymerized without disturbing the orientation of the polymerizable liquid crystal compound.

### <Photosensitizer>

Examples of the photosensitizer include xanthone, and xanthone analogues such as thioxanthone; anthracene, and anthracene analogues such as anthracene having a substituent such as an alkyl ether group; phenothiazine; and rubrene.

The use of the photosensitizer makes it possible to heighten the sensitivity of the photopolymerization initiator. The content of the photosensitizer in the composition is usually from 0.1 to 30 parts by mass, preferably from 0.5 to 10 parts by mass relative to 100 parts by mass of the polymerizable liquid crystal compound in the composition.

### <Levelling Agent>

The levelling agent may be, for example, a polyacrylate based levelling agent, or a perfluoroalkyl-containing levelling agent. Specific examples thereof include the following products: FLUORINERTs (registered trademark) FC-72, FC-40, FC-43, and FC-3283 (all the products are manufactured by Sumitomo 3M Limited); MEGAFACs (registered trademark) R-08, R-30, R-90, F-410, F-411, F-443, F-445, F-470, F-477, F-479, F-482, and F-483 (all the products are manufactured by DIC Corporation); EFTOPs (trade name) EF301, EF303, EF351, and EF352 (all the products are manufactured by Mitsubishi Material Electronic Chemicals Co., Ltd.); SURFLONs (registered trademark) S-381, S-382, S-383, S-393, SC-101, SC-105, KH-40, and SA-100 (all the products are manufactured by AGC Seimi Chemical Co., Ltd.); E1830 and E5844 ((trade names) manufactured by Daikin Fine Chemical Laboratory, Ltd.); and BM-1000, BM-1100, BYK-352, BYK-353, and BYK-361N ((trade names) manufactured by BM Chemie GmbH). Such levelling agents may be used in any combination of two or more thereof.

The use of the levelling agent makes it possible to obtain a smoother optically anisotropic film. Further, during the production process of the optically anisotropic film, the fluidity of the composition for forming an optically anisotropic film can be controlled or the crosslinkage density of the optically anisotropic film is adjusted. The content of the levelling agent in the composition is usually from 0.1 to 30 parts by mass, preferably from 0.1 to 10 parts by mass relative to 100 parts by mass of the polymerizable liquid crystal compound in the composition.

### [Chiral Agent]

The chiral agent may be a known chiral agent (for example, agents described in “Liquid Crystal Device Handbook”, Chapter 3, 4-3, Chiral Agents for TN and STN, p. 199, edited by Japan Society for the Promotion of Science, 142 Committee, 1989).

The chiral agent generally contains an asymmetric carbon atom. The chiral agent may be an axially asymmetric compound or planarly asymmetric compound, which contains no asymmetric carbon atom. Examples of the axially asymmetric compound or planarly asymmetric compound include binaphthyl, helicene, paracyclophane, and derivatives of these compounds.

The examples of the chiral agent include compounds as described in JP-A-2007-269639, JP-A-2007-269640, JP-A-2007-176870, JP-A-2003-137887, JP-A-2000-515496, JP-A-2007-169178, and JP-A-09-506088. The chiral agent is preferably a product Paliocolor (registered trademark) LC756 manufactured by the company BASF Japan Ltd.

The content of the chiral agent in the composition is usually from 0.1 to 30 parts by mass, preferably from 1.0 to 25 parts by mass relative to 100 parts by mass of the polymerizable liquid crystal compound in the composition in order to polymerize the polymerizable liquid crystal compound without disturbing the orientation of the polymerizable liquid crystal compound.

### <Reactive Additive>

The reactive additive is preferably a compound having a carbon-carbon unsaturated bond and an active hydrogen reactive group in the its molecule. The term of “active hydrogen reactive group” herein means a group reactive with a group having an active hydrogen atom, such as a carboxyl group (—COOH), hydroxyl group (—OH) or amino group (—NH₂). The examples thereof include epoxy, oxazoline, carbodiimide, aziridine, imide, isocyanate, thioisocyanate, and maleic anhydride groups.

It is preferred that the reactive additive has at least two active hydrogen reactive groups. In this case, the active hydrogen reactive groups may be the same as or different from each other.

The carbon-carbon unsaturated bond of the reactive additive may be a carbon-carbon double bond, a carbon-carbon triple bond, or the both of them, and is preferably a carbon-carbon double bond. It is particularly preferred that the reactive additive contains a vinyl group and/or a (meth)acrylic group as its carbon-carbon unsaturated bond(s). Furthermore, the reactive additive is preferably a compound having at least one selected from the group consisting of epoxy, glycidyl and isocyanate groups; and is in particular preferably a reactive additive having an acrylic group and an isocyanate group as its active hydrogen reactive group(s).

The examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline, and isopropenyl oxazoline; and oligomers each made from a compound having a (meth)acrylic group and an isocyanate group, such as isocyanatomethyl acrylate, isocyanatomethyl methacrylate, 2-isocyanatoethyl acrylate, and 2-isocyanatoethyl methacrylate. Other examples thereof include compounds each having a vinyl group or vinylene group and an acid anhydride, such as methacrylic anhydride, acrylic anhydride, maleic anhydride, and vinylmaleic anhydride. Of these examples, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethylacrylate, 2-isocyanatoethylacrylate, and the oligomers.

Such a preferred reactive additive is represented by the following formula (Y):

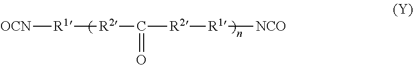

wherein n represents an integer of 1 to 10, R^{1′}s each independently represent a bivalent aliphatic or alicyclic hydrocarbon group having 2 to 20 carbon atoms, or a bivalent aromatic hydrocarbon group having 5 to 20 carbon atoms; and the one of two R^{2′} in each of the repeating units is a group represented by —NH— and the other is a group represented by >N—C(═O)—R^{3′} wherein R^{3′} represents a hydroxyl group, or a group having a carbon-carbon unsaturated bond.

When n is 2 or more, at least one of R^{3′}s in >N—C(═O)—R^{3′} groups is preferably a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”):

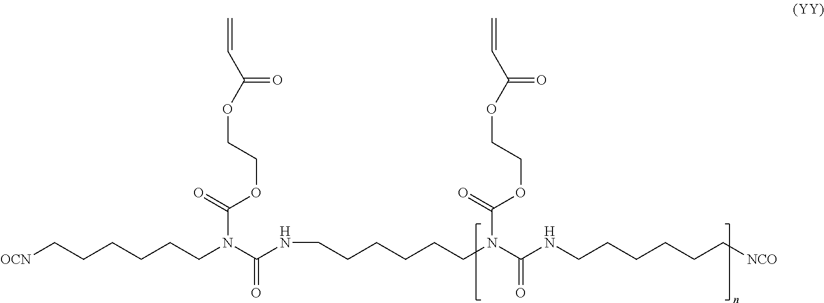

As the compound (YY), a commercially available product is usable as it is, or in the state of being purified if necessary. An example of the commercially available product is a product Laromer (registered trademark) LR-9000 (manufactured by the company BASF).

The content of the reactive additive in the composition is usually from 0.1 to 30 parts by mass, preferably from 0.1 to 5 parts by mass relative to 100 parts by mass of the polymerizable liquid crystal compound.

### <Application>

Examples of the method for applying the composition for forming an optically anisotropic film onto the substrate include extrusion coating, direct gravure coating, reverse gravure coating, CAP coating, slit coating, and die coating methods; and a method of attaining the applying, using a coater such as a dip coater, a bar coater, or a spin coater. Preferred are CAP coating, inkjet coating, dip coating, slit coating, die coating, and bar-coater-used coating methods since these methods make it possible to attain the applying continuously in a roll-to-roll manner. When this composition is applied in a roll-to-roll manner, it is allowable to form an orientation film onto the substrate, and further apply the composition for forming an optically anisotropic film continuously onto the resultant orientation film.

The method for polymerizing the polymerizable liquid crystal compound is preferably a photopolymerization method. According to the photopolymerization, the compound can be polymerized at a lower temperature and thus, the resin used for a substrate to be used can be increased in the viewpoint of the heat resistance of the resin. The photopolymerization reaction is usually conducted by the radiation of visible rays, ultraviolet rays, or a laser ray, and is preferably conducted by the radiation of ultraviolet rays.

When the applied composition for forming an optically anisotropic film contains the solvent, the light radiation is preferably performed after the solvent is dried to be removed. The drying may be performed simultaneously with the light radiation. It is however preferred to remove almost all of the solvent before the light radiation.

The method for the drying may be an usual drying method. Examples of the ordinary drying method include natural drying, ventilation drying, heat drying, and reduced-pressure drying; and any combination of two or more of these methods. Of these examples, preferred are natural drying and heat drying. The drying temperature is preferably from 0 to 250° C., more preferably from 50 to 220° C., even more preferably from 80 to 170° C. The drying period is preferably from 10 seconds to 60 minutes, more preferably from 30 seconds to 30 minutes.

When the optically anisotropic film exhibits a liquid crystal phase such as a nematic phase, the film has a birefringence property based on mono-domain orientation. In the present optically an isotropic film, the orientation of the polymerizable liquid crystal compound is fixed so that the film is not easily affected by a birefringence change by heat.

The present optically anisotropic film is usable as a retardation film for a viewing angle compensating film, a viewing angle enlarging film, an antireflective film, a polarizing plate, a circularly polarizing plate, an elliptically polarizing plate, or a brightness enhancement film.

Furthermore, the present optically anisotropic film can be changed in optical property in accordance with the orientation state of the polymerizable liquid crystal compound. The optically anisotropic film is usable as a retardation film for a liquid crystal display device that may be in various modes such as a vertical alignment (VA) mode, an in-plane switching (IPS) mode, an optically compensated bend (OCB) mode, a twisted nematic (TN) mode, and a super twisted nematic (STN) mode.

The present optically anisotropic film is also useful as a member which constitutes a polarizing plate. The polarizing plate of the present invention is a plate including at least one of the present optically anisotropic film, and films identical or equivalent thereto.

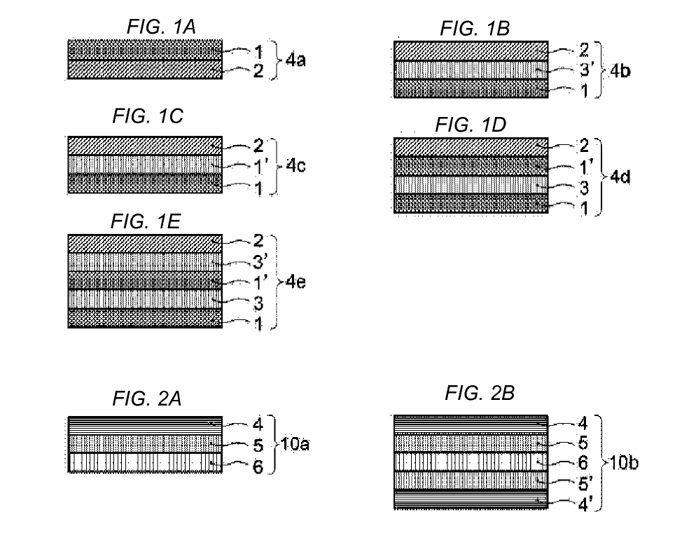

The examples of the polarizing plate 4 include respective polarizing plates 4a to 4e illustrated in FIGS. 1A to 1E. The polarizing plate 4a illustrated in FIG. 1A is a polarizing plate in which a retardation film 1 and a polarization film 2 are laminated directly onto each other. The polarizing plate 4b illustrated in FIG. 1B is a polarizing plate in which a retardation film 1 and a polarization film 2 are bonded onto each other through an adhesive layer 3′. The polarizing plate 4c illustrated in FIG. 1C is a polarizing plate in which retardation films 1 and 1′ are laminated onto each other and further a polarization film 2 is laminated onto the retardation film 1′. The polarizing plate 4d illustrated in FIG. 1D is a polarizing plate in which retardation films 1 and 1′ are bonded onto each other through an adhesive layer 3, and further a polarization film 2 is laminated onto the retardation film 1′. The polarizing plate 4e illustrated in FIG. 1E is a polarizing plate in which retardation films 1 and 1′ are bonded onto each other through an adhesive layer 3, and further the retardation film 1′ and a polarization film 2 are bonded onto each other through an adhesive layer 3′. The wording “adhesive” is a generic name of any adhesive and/or any binder. At least one selected from the group consisting of the retardation film 1 and the retardation film 1′ includes the present optically anisotropic film.

It is sufficient for the polarization film 2 to be a film having a polarizing function. Examples of the film include a drawn film to which a dye having absorption anisotropy is adsorbed, and a film to which a dye having absorption anisotropy is applied. Examples of the dye having absorption anisotropy include iodine, azo compounds, and other dichroic dyes.

Examples of the drawn film to which a dye having absorption anisotropy is adsorbed include a film obtained by adsorbing a dichroic dye to a polyvinyl alcohol based film, and then drawing the resultant; and a film obtained by drawing a polyvinyl alcohol based film, and then adsorbing a dichroic dye to the resultant.

The film to which a dye having absorption anisotropy is applied is, for example, a film obtained by applying a composition containing a dichroic dye having liquid crystal property, or applying a composition containing a dichroic dye and a polymerizable liquid crystal compound.

The film having a polarizing function preferably has, on a surface or each surface thereof, a protective film. Examples of the protective film are identical with the examples of the above-mentioned substrate.

Specific examples of the drawn film to which a dye having absorption anisotropy is adsorbed include polarizing plates described in Japanese Patent Nos. 3708062 and 4432487.

Specific examples of the film to which a dye having absorption anisotropy is applied include polarization films described in JP-A-2012-33249.

As the polarization film 2 is smaller in thickness, the film is more favorable. However, if the polarization film 2 is too thin, the film tends to be lowered in strength to be deteriorated in workability. The thickness of the polarization film is usually from 0.1 to 300 μm, preferably from 1 to 200 μm, more preferably from 5 to 100 μm.

The adhesive that forms the adhesive layers 3 and 3′ is preferably an adhesive high in transparency and excellent in heat resistance. Examples of the adhesive include acrylic based, epoxy based and urethane based adhesives.

The present optically anisotropic film is usable in a display device. Examples of the display device include a liquid crystal display device having a liquid crystal panel in which an optically anisotropic film is stacked on a liquid crystal panel body, and an organic electroluminescence (hereinafter also referred to as EL) display device having an organic EL panel in which an optically anisotropic film and a luminous layer are stacked onto each other. The following will describe a liquid crystal display device as an embodiment of the display device having the present optically anisotropic film.

In embodiments, the liquid crystal display devices are shown as liquid crystal display devices 10a and 10b illustrated in FIGS. 2A and 2B, respectively. In the liquid crystal display device 10a illustrated in FIG. 2A, a polarizing plate 4 of the present invention and a liquid crystal panel 6 are bonded through an adhesive layer 5. In the liquid crystal display device 10b illustrated in FIG. 2B, a polarizing plate 4 of the present invention is bonded to one of the two main surfaces of a liquid crystal panel 6 through an adhesive layer 5 while a polarizing plate 4′ of the invention is bonded to the other main surface of the liquid crystal panel 6 through an adhesive layer 5′. Electrodes not illustrated are used in these liquid crystal display devices to apply a voltage to their liquid crystal panel to change the orientation of molecules of their liquid crystal. In this way, a monochrome display can be realized.

### EXAMPLES

Hereinafter, the present invention will be more specifically described by way of working examples thereof. In the examples, the symbol “%” and the word “part (s)” denote “% by mass” and “part (s) by mass”, respectively, unless otherwise specified.

### [Preparation of a Composition for Forming Orientation Film]

Composition (i.e., four components) of a composition for forming orientation film (1) is shown in Table 1. Three thereof, i.e., N-methyl-2-pyrrolidone, 2-butoxyethanol, and ethylcyclohexane were added to one thereof, i.e., a commercially available orienting polymer, SUNEVER SE-610 (manufactured by Nissan Chemical Industries, Ltd.) to yield the composition for forming orientation film (1).

TABLE 1

| | Orienting | | | |
|---|---|---|---|---|
| | polymer | N-methyl-2- | 2-Butoxy- | Ethyl- |
| | SE-610 | pyrrolidone | ethanol | cyclohexane |
| composition for | 0.5% | 72% | 18.4% | 9.1% |
| forming an | | | | |
| orientation | | | | |
| film (1) | | | | |

Each value in Table 1 represents the proportion of the amount of one of the components in the total amount of the prepared composition. About the polymer SE-610, the solid content by percentage therein was obtained by conversion from the concentration described in a delivery specification statement thereof.

### [Preparation of a Composition for Forming an Optically Anisotropic Film]

Components of each composition for forming an optically anisotropic film are shown in Table 2. The individual components were mixed with each other, and the resultant solution was stirred at 80° C. for 1 hour, and then cooled to room temperature to yield any one of compositions for forming an optically anisotropic film (1) to (4).

TABLE 2

| | Polymer- | | | | |
|---|---|---|---|---|---|
| | izable | Photo- | Organic | | |
| | liquid | polymer- | modified | | |
| | crystal | ization | poly- | Reactive | |
| | compound | initiator | siloxane | additive | Solvent |
| Composition | LC242 | Irg907 | BYK-330 | LR9000 | PGMEA |
| for forming | (19.2%) | (0.5%) | (0.1%) | (1.1%) | (79.1%) |
| an optically | | | | | |
| anisotropic | | | | | |
| film (1) | | | | | |
| Composition | LC242 | Irg907 | — | LR9000 | PGMEA |
| for forming | (19.2%) | (0.5%) | | (1.1%) | (79.2%) |
| an optically | | | | | |
| anisotropic | | | | | |
| film (2) | | | | | |
| Composition | LC242 | Irg907 | BYK-330 | LR9000 | PGMEA |
| for forming | (19.2%) | (0.5%) | (0.2%) | (1.1%) | (79.0%) |
| an optically | | | | | |
| anisotropic | | | | | |
| film (3) | | | | | |
| Composition | LC242 | Irg907 | BYK-330 | LR9000 | PGMEA |
| for forming | (19.2%) | (0.5%) | (1.0%) | (1.1%) | (78.2%) |
| an optically | | | | | |
| anisotropic | | | | | |
| film (4) | | | | | |

A value in each pair of parentheses in Table 2 represents the proportion of the amount of one of the components in the total amount of one of the prepared compositions.

In Table 2, LR9000 represents LAROMER (registered trademark) LR-9000 manufactured by BASF Japan Ltd.; Irg907, IRGACURE 907 manufactured by BASF Japan Ltd.; BYK330, an organic modified polysiloxane manufactured by BYK Japan K.K.; LC242, a polymerizable liquid crystal compound illustrated below, manufactured by BASF; and PGMEA, propylene glycol 1-monomethyl ether 2-acetate.

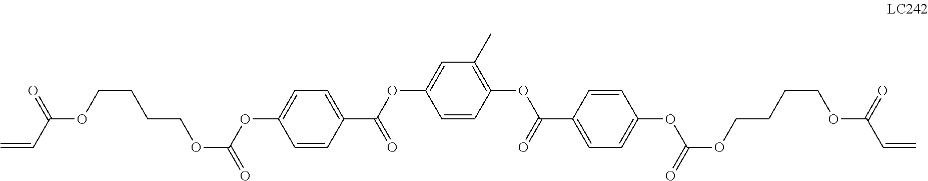 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

### Example 1

A normal-pressure plasma surface-treating machine (roll direct head type AP-T04S-R890, manufactured by Sekisui Chemical Co., Ltd.) was used to generate plasma at 1.3 kV in an atmosphere containing nitrogen and oxygen (ratio by volume of nitrogen to oxygen=99.9/0.1) to treat a surface of a roll-form cycloolefin polymer film (ZF-14, manufactured by Zeon Corp.) with the plasma over a length of 100 m. A die coater was used to apply the composition for forming orientation film (1) onto the cycloolefin polymer film surface subjected to the plasma treatment. The resultant workpiece was carried to a hot-wind drying furnace of 90° C. temperature to be dried for 1 minute. In this way, an orientation film was yielded. Subsequently, a die coater was used to apply the composition for forming an optically anisotropic film (1) onto the outer surface of the resultant orientation film, and the workpiece was carried to a drying furnace of 80° C. temperature to be dried for 1 minute. A high-pressure mercury lamp (manufactured by GS Yuasa Corp.) was used to radiate ultraviolet rays to the workpiece at an illuminance of 160 W/cm at a wavelength of 365 nm to yield a roll-form retardation film (1) having the optically anisotropic film (1).

### Reference Example 1

The normal-pressure plasma surface-treating machine (roll direct head type AP-T04S-R890, manufactured by Sekisui Chemical Co., Ltd.) was used to generate plasma at 1.3 kV in an atmosphere containing nitrogen and oxygen (ratio by volume of nitrogen to oxygen=99.9/0.1) to treat a surface of a roll-form cycloolefin polymer film (ZF-14, manufactured by Zeon Corp.) with the plasma over a length of 100 m. A die coater was used to apply the composition for forming orientation film (1) onto the cycloolefin polymer film surface subjected to the plasma treatment. The resultant workpiece was carried to a hot-wind drying furnace of 90° C. temperature to be dried for 1 minute. In this way, an orientation film was yielded. Subsequently, a die coater was used to apply the composition for forming an optically anisotropic film (2) onto the outer surface of the resultant orientation film, and the workpiece was carried to a drying furnace of 80° C. temperature to be dried for 1 minute. A high-pressure mercury lamp (manufactured by GS Yuasa Corp.) was used to radiate ultraviolet rays to the workpiece at an illuminance of 160 W/cm at a wavelength of 365 nm to yield a roll-form retardation film (2) having the optically anisotropic film (2).

### Example 2

A roll-form retardation film (3) having the optically anisotropic film (3) was yielded in the same way as in Example 1 except that the composition for forming an optically anisotropic film (3) was used.

### Example 3

A roll-form retardation film (4) having the optically anisotropic film (4) was yielded in the same way as in Example 1 except that the composition for forming an optically anisotropic film (4) was used.

### [Optical Property Measurement]

The retardation value of each of the retardation films (1) to (4) was measured (with a measurement instrument, KOBRA-WR, manufactured by Oji Scientific Instruments) while the incident angle of light radiated thereinto was changed. In this way, the orientation state of the polymer of the polymerizable liquid crystal compound in the optically anisotropic film was checked. The results are shown in Table 3.

### [Contact Angle Measurement]

An instrument, Drop Master 700, manufactured by Kyowa Interface Science Co., Ltd. was used to measure the contact angle of each optically anisotropic film-side surface of the retardation films (1) to (4) with water, using a liquid droplet method (liquid volume: 1.1 μL). The results are shown in Table 3.

### [Transparency Evaluation]

A haze meter (model: HZ-2) manufactured by Suga Test Instruments Co., Ltd. was used to measure the haze value of each of the retardation films (1) to (4), using a double beam method. The results are shown in Table 3.

### [Thickness Distribution and Unevenness]

A scattering in the distribution of the thickness of each of the optically anisotropic films (1) to (4) was measured, using an ellipsometer, M-220, manufactured by JASCO Corp.

Each of the retardation films (1) to (4) was arranged between polarizing plates arranged to make their absorption axes perpendicular to each other. It was checked whether or not the retardation film was uneven. The results are shown in Table 3.

TABLE 3

| | | | | Thickness | |
|---|---|---|---|---|---|
| | | Contact | Haze | distribution | Uneven- |
| | Orientation | angel | value | scattering | ness |
| Example 1 | Vertical | 89.7° | 0.15% | ±1.5% | Absent |
| | orientation | | | | |
| Example 2 | Vertical | 89.4° | 0.12% | ±1.4% | Absent |
| | orientation | | | | |
| Example 3 | Vertical | 89.5° | 0.16% | ±1.8% | Absent |
| | orientation | | | | |
| Reference | Vertical | 84.8° | 3.37% | ±3.0% | Present |
| Example 1 | orientation | | | | |

The retardation film having the optically anisotropic film produced in each of the working examples was low in haze value to be high in transparency.

The optically anisotropic film of the present invention is excellent in transparency to be useful.

1. An optically anisotropic film comprising a polymer of a polymerizable liquid crystal compound and an organic modified polysiloxane and having a refractive index relationship of nz>nx>ny
where nz represents a refractive index of an index ellipsoid formed from the optically anisotropic film, the refractive index being taken in a direction vertical to a plane of the film; nx represents a main refractive index of the index ellipsoid formed from the optically anisotropic film, this refractive index being taken in a direction parallel to the plane of the film; and ny represents a refractive index of the index ellipsoid formed from the optically anisotropic film, this refractive index being taken in a direction parallel to the plane of the film and perpendicular to the direction in which the refractive index nx is taken.

2. The optically anisotropic film according to claim 1, wherein the content of the organic modified polysiloxane is from 0.1 to 30 parts by mass relative to 100 parts by mass of the optically anisotropic film.

3. The optically anisotropic film according to claim 1, wherein the polymer of the polymerizable liquid crystal compound is a polymer of a vertically oriented polymerizable liquid crystal compound.

4. The optically anisotropic film according to claim 2, wherein the polymer of the polymerizable liquid crystal compound is a polymer of a vertically oriented polymerizable liquid crystal compound.

5. The optically anisotropic film according to claim 3, wherein the organic modified polysiloxane has a polyether-modified polydimethylsiloxane structure.

6. The optically anisotropic film according to claim 5, the film having the water contact angle of from 70° to 100°.

7. The optically anisotropic film according to claim 1, the film being obtained from a composition for forming an optically anisotropic film, the composition comprising the polymerizable liquid crystal compound and the organic modified polysiloxane.

8. The optically anisotropic film according to claim 1, the film being for an in-plane switching (IPS) liquid crystal display device.

9. A retardation film comprising the optically anisotropic film according to claim 1.

10. A polarizing plate comprising the optically anisotropic film according to claim 1.

11. A display device comprising the optically anisotropic film according to claim 1.

12. A composition for forming an optically anisotropic film, the composition comprising a polymerizable liquid crystal compound and an organic modified polysiloxane in an amount of 0.1 to 30 parts by mass relative to 100 parts by mass of the polymerizable liquid crystal compound.

13. The composition according to claim 12 further comprising a compound having an isocyanate group.
